(19) United States
(12) Patent Application Publication
(10) Pub. No.: US 2002/0097806 A1
(43) Pub. Date: Jul. 25, 2002

(54) Baseband I and Q converter and method for performing baseband I and Q conversion

(76) Inventor: Chih-Fei J. Wang, Issaquah, WA (US)

Correspondence Address: Robert M. Storwick, P.O. Box 386, Mercer Island, WA, 98040, US

(21) Appl. No.: 09/929,815

(22) Filed: Aug. 13, 2001

Related U.S. Application Data
(60) Provisional application No. 60/224,950, filed on Aug. 11, 2000.

(51) Int. Cl. H04L 5/12

(52) U.S. Cl. 375/261; 455/118

(57) ABSTRACT

Intermediate or radio frequency signals are band pass filtered by two band pass filters having identical frequencies, but 90 degree relative phase shifts at the output, with a reduced sampling rate. The outputs of the two BPFs represent in-phase (I) and quadrature-phase (Q) baseband signals needed for demodulation.

### REFERENCE TO PROVISIONAL APPLICATIONS

This application claims the benefit of the U.S. Provisional Application No. 60/224,950, filed Aug. 11, 2000.

### TECHNICAL FIELD

The present invention relates to methods and apparatus for conversion of radio signals, and more particularly, to method and apparatus for conversion of intermediate frequencies to baseband frequencies in a radio receiver.

### BACKGROUND OF THE INVENTION

In the prior art it is known to convert an intermediate frequency (IF) signal to baseband signals by down-sampling the output of a band pass filter (BPF) having a delayed output and a non-delayed output. This is shown in FIG. 1, which is a block diagram of a signal converter known in the prior art.

The converter 100 receives an analog signal at the input to an analog-to-digital (A/D) converter 102 which operates at a sampling frequency Fₛ₀ The digital signals from the A/D converter 102 pass through a band pass frequency (BPF) 104, whose output is passed through a 1/N down sampler 106 on input 108. The output of the BPF 104 is also passed through a delay element 110, whose output is passed through the 1/N down sampler 106 on input 112. The delay created by the delay element 110 must be exactly ¼ of the sampling time period of the carrier frequency of the signal (i.e., 1/(4f₀), where f₀ is the carrier frequency of the signal) to reflect the 90 degree phase shift.

The 1/N down sampler 106 has two samplers—one for each of the inputs 108 and 112. The outputs of the samplers are respectively placed on outputs 114 and 116 of the 1/N down sampler 106. The outputs are then passed through the two respective low pass filters (LPFs) 118 and 120 to generate the I and Q signals.

It is inherently difficult to generate an exact clock delay with the desired resolution in a digital system. Accordingly, it is desirable to implement a converter in a manner that does not require the production of a precise delay.

### SUMMARY OF THE INVENTION

According to one aspect, the invention is a converter for converting an intermediate frequency (IF) signal to a baseband signal, the IF signal having a center frequency of f₀ and bandwidth R. The converter includes a Σ-Δ A/D converter for converting the IF signal to an output signal by sampling the IF signal at a sampling rate Fₛ₀, where Fₛ₀=f₀/N (N an integer) and Fₛ₀>R. The converter also includes a first band pass filter for producing an I signal, the first band pass filter including a first finite-impulse response (FIR) filter operating at a sampling rate Fₛ₂, where R≦Fₛ₂<Fₛ₀; and a second band pass filter for producing a Q signal, the second band pass filter including a second FIR filter operating at the sampling rate Fₛ₂, such that the phases of the I and Q signals differ by 90 degrees.

According to another aspect, the invention is a method for converting an intermediate frequency (IF) signal to a baseband signal, the IF signal having a center frequency of f₀ and bandwidth R. The method includes the step of a) converting the IF signal to an output signal by using a Σ-Δ A/D converter for sampling the IF signal at a sampling rate Fₛ₀, where Fₛ₀=fₛ₀/N (N an integer) and Fₛ₀>R. The method also includes the step of b) producing an I signal by passing the output signal through a first band pass filter including a first finite-impulse response (FIR) filter operating at a sampling rate Fₛ₂, where R≦Fₛ₂<Fₛ₀. The method also includes the step of c) producing a Q signal by passing the output signal through a second band pass filter including a second FIR filter operating at the sampling rate Fₛ₂, such that the phases of the I and Q signals differ by 90 degrees.

According to yet another aspect, the invention is a converter for converting an intermediate frequency (IF) signal to a baseband signal, the IF signal having a center frequency of f₀ and bandwidth R. The converter includes means for converting the IF signal to an output signal by using a Σ-Δ A/D converter for sampling the IF signal at a sampling rate Fₛ₀, where Fₛ₀−f₀/N (N an integer) and Fₛ₀>R. The converter also includes means for producing an I signal by passing the output signal through a first band pass filter including a first finite-impulse response (FIR) filter operating at a sampling rate Fₛ₂, where R≦Fₛ₂<Fₛ₀. The converter further includes means for producing a Q signal by passing the output signal through a second band pass filter including a second FIR filter operating at the sampling rate Fₛ₂, such that the phases of the I and Q signals differ by 90 degrees.

### BRIEF DESCRIPTION OF TRE DRAWINGS

FIG. 1 is a block diagram of an I and Q converter known in the prior art.

FIG. 2 is a block diagram of a first preferred embodiment of an improved I and Q converter in accordance with the present invention.

FIG. 3 is a block diagram of a second preferred embodiment of an improved I and Q converter in accordance with the present invention.

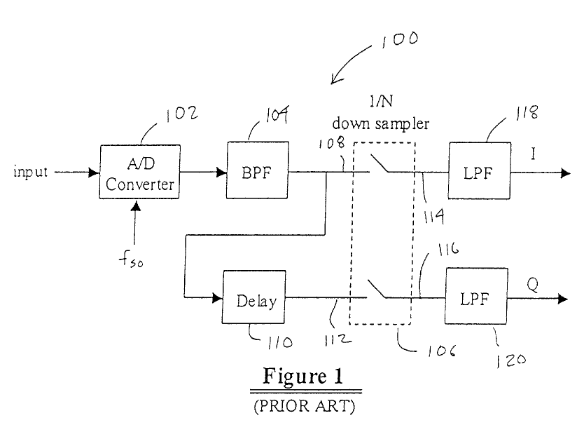

### DETAILED DESCRIPTION OF THE PREFERRED EMBODIMENT OF THE INVENTION

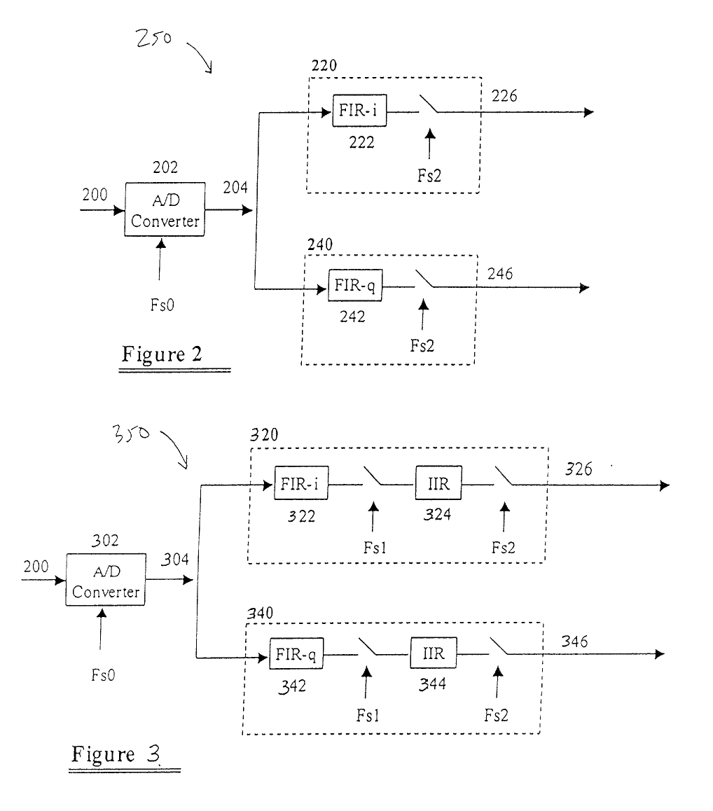

FIG. 2 is a block diagram of a first preferred embodiment of an improved I and Q converter in accordance with the present invention. This converter 250 can be used to convert from an IF to baseband I and Q signals. The converter 250 includes a sigma-delta analog-to-digital (Σ-Δ A/D) converter 202, and BPF filter blocks 220 and 240. The BPF filter blocks 220 and 240 receive their inputs from the Σ-Δ A/D converter 202, which operates at a sampling rate Fₛ₀.

In operation, the converter 250 receives an incoming signal 200 having a center frequency of f₀ and bandwidth R. The incoming signal 200 is digitized by Σ-Δ A/D converter 202 at a sampling rate Fₛ₀, Fₛ₀=f₀/N and Fₛ₀>R. The output of Σ-Δ A/D converter 202 is band pass filtered by the BPF filter blocks 220 and 240. Each of the BPF filter blocks 220 and 240 includes a finite-impulse response (FIR) filter. BPF filter block 220 includes the FIR filter 222 (FIR-i), and BPF filter block 240 includes the FIR filter 242 (FIR-q). The BPF filter blocks 220 and 240 operate at the sampling rate Fₛ₂, R≦Fₛ₂<Fₛ₀, and respectively generate the I and Q signals 226 and 246.

The BPF filter blocks 220 and 240 have identical frequency responses, except that their time domain responses are 90 degrees out of phase. The FIR filter 222 can be designed by using a typical low pass filter (LPF) design process to obtain the impulse response of the FIR. The bandwidth of the LPF is greater than or equal to R/2. Next, the LPF impulse response is multiplied by a sine function having a center frequency of f₀.

As an example of typical LPF design, a brick wall filter can be designed using a SINC function (sin x/x), and the resulting impulse response is truncated by a conventional window function such as the Hamming window.

The FIR filter 242 can designed with the same procedure except that the LPF impulses response is multiplied by a cosine function having a center frequency of f₀.

Depending on the bandwidth of FIR filters 222 and 224, additional bandlimiting can be provided by post demodulation LPFs.

FIG. 3 is a block diagram of a second preferred embodiment of an improved I and Q converter in accordance with the present invention. The converter 350 is very similar to the converter 250 shown in FIG. 2. The converter 350 includes a sigma-delta analog-to-digital (Σ-Δ A/D) converter 302, and BPF filter blocks 320 and 340. The BPF filter blocks 320 and 340 receive their inputs from the Σ-Δ A/D converter 302, which operates at a sampling rate Fₛ₀.

In operation, the converter 350 receives an incoming signal 200 having a center frequency of f₀ and bandwidth R. The incoming signal 200 is digitized by Σ-Δ A/D converter 302. The output of Σ-Δ A/D converter 302 is band pass filtered by the BPF filter blocks 320 and 340. Each of the BPF filter blocks 320 and 340 includes a finite-impulse response (FIR) filter and an infinite-impulse response (IIR) filter. BPF filter block 320 includes the FIR filter 322 (FIR-i) and the IIR filter 324. The BPF filter block 340 includes the FIR filter 342 (FIR-q) and the IIR filter 344.

The IIR filters 324 and 344 reduce the computational power required to implement the BPF blocks 320 and 340. The signal 304 entering the BPF block 320 is first filtered by the FIR BPF 322 for an initial bandwidth reduction. The bandwidth reduced signal is down sampled at Fₛ₁ samples per second and filtered by the IIR BPF 324. Further bandwidth reduction by the IIR BPF 324 allows the signal to be down sampled to produce output signal 324 at the final sampling rate Fₛ₂. The BPF block 340 is implemented in a similar manner except that FIRs 322 and 342 are designed with the earlier mentioned principle to produce output with 90 degrees phase shifts.

The BPF filter blocks 320 and 340 operate at the sampling rate Fₛ₂ and respectively generate the I and Q signals 326 and 346.

Although the present invention is described as using a Σ-Δ A/D converter, it works well with all types of A/D converters. Advantages of using a Σ-Δ A/D converter include its oversampling and one-bit output.

While the foregoing is a detailed description of the preferred embodiment of the invention, there are many alternative embodiments of the invention that would occur to those skilled in the art and which are within the scope of the present invention.

1. A converter for converting an intermediate frequency (IF) signal to a baseband signal, the IF signal having a center frequency of f₀ and bandwidth R, comprising:
a Σ-Δ A/D converter for converting the IF signal to an output signal by sampling the IF signal at a sampling rate Fₛ₀, where Fₛ₀=f₀/N (N an integer) and Fₛ₀>R;
a first band pass filter for producing an I signal, the first band pass filter including a first finite-impulse response (FIR) filter operating at a sampling rate Fₛ₂, where R≦Fₛ₂<Fₛ₀; and
a second band pass filter for producing a Q signal, the second band pass filter including a second FIR filter operating at the sampling rate Fₛ₂,
such that the phases of the I and Q signals differ by 90 degrees.

2. The converter of claim 1, wherein the first and second band pass filters are designed as low pass filters having bandwidths greater than or equal to R/2 and having impulse responses, respectively, the impulse response of the low pass filter design of the first band pass filter being multiplied by a sine function having a center frequency of f₀, and the impulse response of the low pass filter design of the second band pass filter being multiplied by a cosine function having a center frequency of f₀.

3. The converter of claim 2, wherein the first and second band pass filters are designed as low pass filters using a SINC function.

4. The converter of claim 2, wherein the impulse responses of the first and second band pass filters are truncated by a conventional window function.

5. The converter of claim 4, wherein the window function is the Hamming window function.

6. A method for converting an intermediate frequency (IF) signal to a baseband signal, the IF signal having a center frequency of f₀ and bandwidth R, comprising the steps of:
a) converting the IF signal to an output signal by using a Σ-Δ A/D converter for sampling the IF signal at a sampling rate Fₛ₀, where Fₛ₀=f₀/N (N an integer) and Fₛ₀>R;
b) producing an I signal by passing the output signal through a first band pass filter including a first finite-impulse response (FIR) filter operating at a sampling rate Fₛ₂, where R≦Fₛ₂<Fₛ₀; and
C) producing a Q signal by passing the output signal through a second band pass filter including a second FIR filter operating at the sampling rate Fₛ₂,
such that the phases of the I and Q signals differ by 90 degrees.

7. The method of claim 6, wherein step b) includes designing the first band pass filter as a low pass filter having a bandwidth greater than or equal to R/2 and having a first impulse response that is multiplied by a sine function having a center frequency of f₀, and
step c) includes designing the second band pass filter as a low pass filter having a bandwidth greater than or equal to R/2 and having a second impulse response that is multiplied by a cosine function having a center frequency of f₀.

8. The method of claim 7, wherein steps b) and c) further include respectively designing the first and second band pass filters as low pass filters using a SINC function.

9. The method of claim 7, wherein steps b) and c) further include respectively truncating the impulse responses of the first and second band pass filters by a conventional window function.

10. The method of claim 9, wherein steps b) and c) include respectively truncating the impulse responses of the first and second band pass filters by Hamming window functions.

11. A converter for converting an intermediate frequency (IF) signal to a baseband signal, the IF signal having a center frequency of f₀ and bandwidth R, comprising:
means for converting the IF signal to an output signal by using a Σ-Δ A/D converter for sampling the IF signal at a sampling rate Fₛ₀, where Fₛ₀=f₀/N (N an integer) and Fₛ₀>R;
means for producing an I signal by passing the output signal through a first band pass filter including a first finite-impulse response (FIR) filter operating at a sampling rate Fₛ₂, where R≦Fₛ₂<Fₛ₀; and
means for producing a Q signal by passing the output signal through a second band pass filter including a second FIR filter operating at the sampling rate Fₛ₂,
such that the phases of the I and Q signals differ by 90 degrees.

12. The converter of claim 11, wherein the means for producing an I signal includes a first low pass filter having a bandwidth greater than or equal to R/2 and having a first impulse response that is multiplied by a sine function having a center frequency of f₀, and
the means for producing a Q signal includes a second low pass filter having a bandwidth greater than or equal to R/2 and having a second impulse response that is multiplied by a cosine function having a center frequency of f₀.

13. The converter of claim 12, wherein the means for producing an I signal and for producing a Q signal further include low pass filters using a SINC function.

14. The converter of claim 12, wherein the means for producing an I signal and for producing a Q signal further include respectively means for truncating the impulse responses of the first and second band pass filters by a conventional window function.

15. The converter of claim 14, wherein the means for producing an I signal and for producing a Q signal respectively includes means for truncating the impulse responses of the first and second band pass filters by Hamming window functions.
